(19) United States
(12) Patent Application Publication
(10) Pub. No.: US 2024/0386717 A1
(43) Pub. Date: Nov. 21, 2024

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: TATSUYA YAMAMOTO, Tokyo (JP)

(21) Appl. No.: 18/665,232

(22) Filed: May 15, 2024

(30) Foreign Application Priority Data
May 16, 2023 (JP) 2023-080997

(51) Int. Cl. G06V 10/94; G06F 3/0482; G06F 3/0484

(52) U.S. Cl. CPC G06V 10/945; G06F 3/0484; G06F 3/0482

(57) ABSTRACT

An information processing apparatus includes a first display unit configured to display one or more images, an operation unit configured to select an operation for the one or more images, an identification unit configured to identify at least one display target tag based on the selected operation and a second display unit configured to display information about the at least one display target tag with the one or more images in a case where a tag added to the one or more images corresponds to the at least one display target tag.

### BACKGROUND

### Field of the Disclosure

The present disclosure relates to an information processing apparatus, a method for controlling the information processing apparatus, and a storage medium.

### Description of the Related Art

There are known techniques for managing images and information about tags added to the images and displaying an image with information about a tag added to the image. Japanese Patent Application Laid-Open No. 2020-135665 discusses a technique for displaying a list of tag information added to images and displaying only images tagged with selected tag information.

Information about tags added to images is sometimes used as assists in selecting target images for an operation such as deletion or sharing. However, if there are many types of tags added to the images and information about all the tags is simply displayed, even information about tags that are unrelated to the operation is displayed, which can be bothersome. Further, with the method discussed in Japanese Patent Application Laid-Open No. 2020-135665, it takes some time to designate a tag from various tags.

For example, in deleting images, negative tag information such as information indicating that an image is out of focus, blurred, or too dark or information indicating red eyes or closed eyes of a person is useful, but it is cumbersome for users to designate all the tag information. Furthermore, in a case where images are analyzed and tags are automatically added to the images, users do not know what types of tag information are added as negative tag information to the images, so that it is difficult for the users to make a designation.

### SUMMARY

The present disclosure is directed to displaying suitable tag information for selecting an operation target based on an operation selected for images, in light of the above-described circumstances.

According to an aspect of the present disclosure, an information processing apparatus includes a first display unit configured to display one or more images, an operation unit configured to select an operation for the one or more images, an identification unit configured to identify at least one display target tag based on the selected operation, and a second display unit configured to display information about the at least one display target tag with the one or more images in a case where a tag added to the one or more images corresponds to the at least one display target tag.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of an information processing apparatus according to one or more aspects of the present disclosure.

FIG. 2 is a diagram illustrating an example of a functional configuration of an information processing apparatus according to one or more aspects of the present disclosure.

FIG. 3 is a diagram illustrating an example of an image management table according to one or more aspects of the present disclosure.

FIG. 4 is a diagram illustrating an example of a tag management table according to the first exemplary embodiment.

FIG. 5 is a flowchart illustrating an example of a process of the information processing apparatus according to one or more aspects of the present disclosure.

FIG. 6 is a flowchart illustrating an example of a tag display process according to one or more aspects of the present disclosure.

FIGS. 7A and 7B are diagrams each illustrating an example of a screen displayed in the process according to one or more aspects of the present disclosure.

FIG. 8 is a diagram illustrating an example of a functional configuration of an information processing apparatus according to one or more aspects of the present disclosure.

FIG. 9 is a diagram illustrating an example of a tag management table according to one or more aspects of the present disclosure.

FIG. 10 is a flowchart illustrating an example of a process of the information processing apparatus according to one or more aspects of the present disclosure.

FIG. 11 is a flowchart illustrating an example of a warning display process according to one or more aspects of the present disclosure.

FIG. 12 is a diagram illustrating an example of a screen displayed in the process according to one or more aspects of the present disclosure.

FIG. 13A is a diagram illustrating an example of a system according to the first exemplary embodiment, and 13B is a diagram illustrating an example of a system configuration according to one or more aspects of the present disclosure.

### DESCRIPTION OF THE EMBODIMENTS

Various exemplary embodiments of the present disclosure will be described below with reference to the drawings. Configurations according to the exemplary embodiments described below are merely examples, and the present disclosure is not limited to the illustrated configurations.

According to a first exemplary embodiment, an example will be described in which in a case where an operation for images is selected by a user operation, an information processing apparatus identifies display a target tag or target tags based on the selected operation and displays only information about the corresponding tag(s) among tags added to the images.

### <Hardware Configuration>

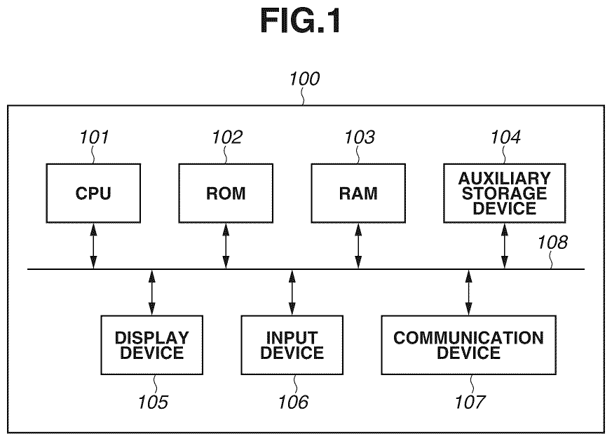

FIG. 1 is a diagram illustrating an example of a hardware configuration of an information processing apparatus according to the present exemplary embodiment. An information processing apparatus 100 includes a central processing unit (CPU) 101, a read only memory (ROM) 102, a random access memory (RAM) 103, an auxiliary storage device 104, a display device 105, an input device 106, a communication device 107, and a system bus 108. The CPU 101, the ROM 102, the RAM 103, the auxiliary storage device 104, the display device 105, the input device 106, and the communication device 107 are connected together via the system bus 108 to communicate with each other.

The CPU 101 is a central processing unit that performs calculations and logical judgements for various processes and controls the components connected to the system bus 108. The ROM 102 is a program memory and stores programs (computer programs) for control including various processes by the CPU 101 described below. The RAM 103 is used as a temporary storage area, such as a main memory of the CPU 101 and a work area. The CPU 101 realizes processes based on flowcharts described below by reading programs stored in the ROM 102 and executing the read programs. The RAM 103 may function as a program memory by loading a program stored in the ROM 102 to the RAM 103. The CPU 101 may write execution results of processes to the RAM 103.

The auxiliary storage device 104 is a storage device that stores various types of data and programs according to the present exemplary embodiment and does not lose data even when the power is turned off. The auxiliary storage device 104 may be realized by, for example, a medium (recording medium) and an external storage drive for allowing access to the medium. Examples of such a medium include a flash memory, a universal serial bus (USB) memory, a solid state drive (SSD) memory, a hard disk drive (HDD), a flexible disk (FD), a compact disk (CD) ROM (CD-ROM), a digital versatile device (DVD), and a Secure Digital (SD) card. The auxiliary storage device 104 may be a server apparatus connected via a network. The auxiliary storage device 104 may be, for example, an SSD memory that is integrated in the main body and is unremovable from the CPU 101. Hereinafter, an example will be described of a case where the auxiliary storage device 104 according to the present exemplary embodiment is a server apparatus connected to an SSD memory integrated in the main body via a network. The RAM 103 may function as a program memory by loading a program stored in the auxiliary storage device 104 to the RAM 103. The CPU 101 may store execution results of processes in the auxiliary storage device 104.

The display device 105 is, for example, a liquid crystal display or an organic electroluminescent (EL) display and is a device that outputs images, text, and graphics on a display screen through processing by the CPU 101.

The display device 105 may be an external device connected to the information processing apparatus 100 via a wire or wirelessly. The input device 106 is, for example, a touch panel, buttons, and a mouse and receives various user operations. The input device 106 may include a pressure-sensitive or capacitive touch panel attached to the display device 105 and configured to detect user operations and/or a light pen. The input device 106 may be an external device, such as a mouse connected to the information processing apparatus 100 via a wire or wirelessly. The communication device 107 performs wired or wireless bi-directional communication with other information processing apparatuses, communication devices, and external storage apparatuses using publicly-known communication techniques.

### <Functional Configuration>

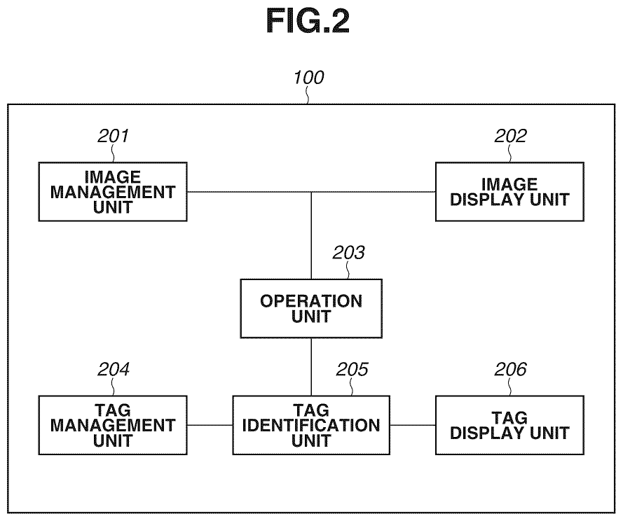

FIG. 2 is a block diagram illustrating an example of a functional configuration of the information processing apparatus 100 according to the present exemplary embodiment.

The information processing apparatus 100 includes an image management unit 201, an image display unit 202, an operation unit 203, a tag management unit 204, a tag identification unit 205, and a tag display unit 206. Functions of the foregoing functional units are realized by, for example, the CPU 101 loading programs stored in the ROM 102 or the auxiliary storage device 104 to the RAM 103 and executing the loaded programs. Further, for example, hardware may be configured, as an alternative to a software process using the CPU 101, to include calculation units or circuits corresponding to processes of the functional units described herein. The components will now be described.

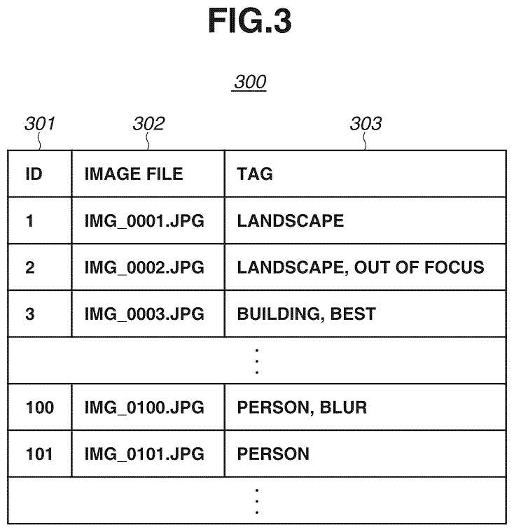

The image management unit 201 manages image files (image data) of images and tag information about tags added to the images using an image management table illustrated as an example in FIG. 3. The image management unit 201 may manage image files and tag information acquired externally via the auxiliary storage device 104 or may store image files and tag information in a predetermined storage area (e.g., the auxiliary storage device 104) and manage the stored image files and the stored tag information. Further, the image management unit 201 may store image files and tag information in a storage unit of an external server apparatus and manage the stored image files and the stored tag information.

FIG. 3 is a diagram illustrating an example of an image management table managed by the image management unit 201.

An image management table 300 is a table for managing an image file of each image and tag information added to the image. Configuration information in the image management table 300 includes an identifier (ID) 301 of each image, an image file 302 of the image, and a tag 303 added to the image. Examples of tags added to images include “landscape”, “building”, and “person” related to subjects, “best” indicating a best shot, “out of focus” indicating that the image is out of focus, and “blur” indicating that the image is blurred. Tags that are added to images are not limited to the foregoing examples. A tag may be added to an image manually by the user or automatically through analysis of the image. According to the present exemplary embodiment, a tag is added to an image automatically based on the likelihood of the tag that is obtained as a result of analyzing the image.

The image display unit 202 displays a list of one or more images managed by the image management unit 201. The image display unit 202 is an example of a first display unit. The operation unit 203 receives inputs from the user (hereinafter, also referred to as “user input”) via the input device 106 and performs operations for images based on the user inputs. The operation unit 203 selects an operation for images, selects operation target images, and performs operations based on the user inputs. Examples of operations for images include a delete operation, a download operation, a search operation, and an operation of sharing with others. Operations for images are not limited to the foregoing examples.

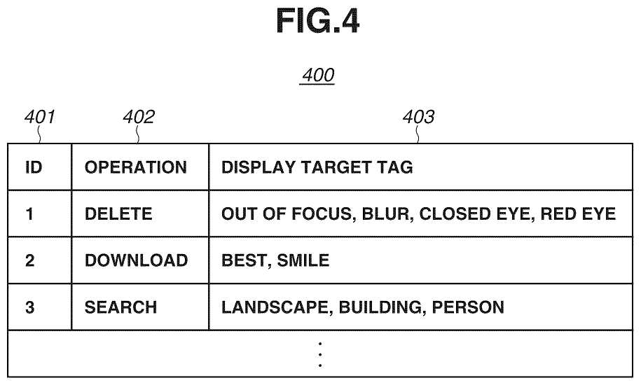

The tag management unit 204 manages operations for images and information about display target tags to be displayed with the images using a tag management table illustrated as an example in FIG. 4. FIG. 4 is a diagram illustrating an example of a tag management table managed by the tag management unit 204. A tag management table 400 is a table for managing operations for images in association with display target tags. Configuration information in the tag management table 400 includes an ID 401 of each operation for images, an operation 402 for images, and a display target tag 403. For delete operations, impressively negative tag information, such as “out of focus”, “blur”, “closed eye”, and “red eye”, is considered useful in selecting operation target images. Further, for download and share operations, impressively positive tag information, such as “best” and “smile”, is considered useful in selecting operation target images. According to the present exemplary embodiment, a tag management table is generated manually in advance based on the above-described know-how and is used.

The tag identification unit 205 receives operation information about an operation selected as an operation for images by user input, from the operation unit 203, and identifies display target tags based on the tag management table managed by the tag management unit 204. In a case where a tag added to an image displayed by the image display unit 202 corresponds to a display target tag identified by the tag identification unit 205, the tag display unit 206 displays information about the display target tag with the image. The tag display unit 206 is an example of a second display unit.

### <Processing Procedure>

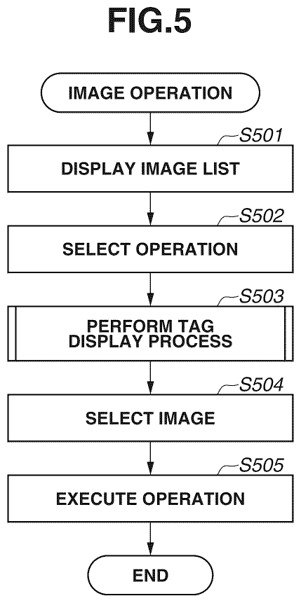

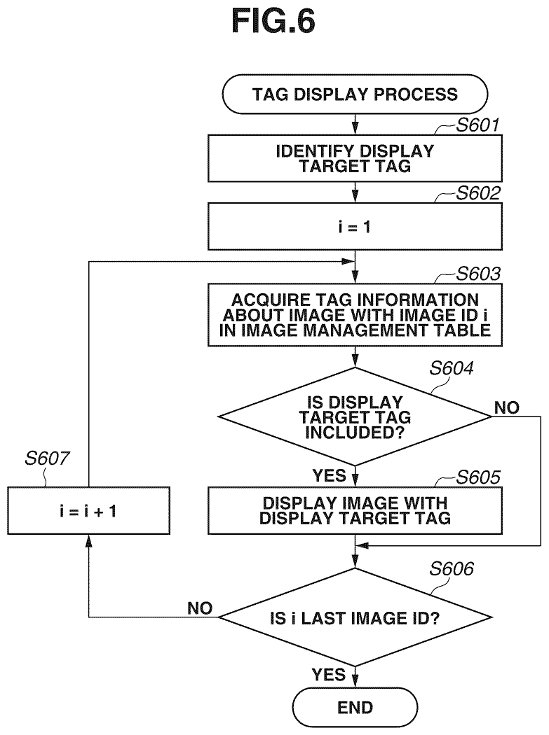

Examples of processes of the information processing apparatus 100 according to the first exemplary embodiment will be described with reference to FIGS. 5 and 6. Hereinafter, the letter “S” is added at the beginning of each step number in the processes in the flowcharts.

FIG. 5 is a flowchart illustrating an example of processing of the information processing apparatus 100 according to the first exemplary embodiment.

FIG. 5 illustrates a procedure of the processing of the information processing apparatus 100 from displaying an image list to executing an operation for images.

In step S501, the image display unit 202 displays an image list based on information in the image management table 300 managed by the image management unit 201. The image display unit 202 acquires image files managed by the image management table 300 from a functional unit or a device storing the image files and displays an image list based on the acquired image files.

In step S502, the operation unit 203 receives a user input related to selecting an operation for images via the input device 106 and selects an operation for images based on the user input. As described above, examples of operations for images include a delete operation, a download operation, a search operation, and an operation of sharing with others. The foregoing operations are merely examples, and operations for images are not limited to the examples.

In step S503, the tag identification unit 205 and the tag display unit 206 perform a tag display process of displaying tag information based on the operation for images that is selected in step S502. In the tag display process, information about display target tags associated with the selected operation for images is displayed with the images based on information in the image management table 300 managed by the image management unit 201 and information in the tag management table 400 managed by the tag management unit 204. Details of the tag display process in step S503 will be described below.

In step S504, the operation unit 203 receives a user input related to selecting an image via the input device 106 and selects an image as a target of the operation for images based on the user input.

In step S505, the operation unit 203 receives a user input related to executing the operation via the input device 106 and executes the operation on the image selected as an operation target in step S504 based on the user input.

FIG. 6 is a flowchart illustrating an example of the tag display process in step S503 in the flowchart in FIG. 5.

In step S601, the tag identification unit 205 acquires information about the operation for images that is selected in step S502 from the operation unit 203 and identifies display target tags to be displayed with images based on information in the tag management table 400 managed by the tag management unit 204. For example, in a case where the selected operation for images is the delete operation, the tag identification unit 205 identifies “out of focus”, “blur”, “closed eye”, and “red eye” tags as display target tags.

In step S602, the tag display unit 206 initializes a variable i indicating the image ID in the image management table 300 managed by the image management unit 201 to 1. The variable i is used in referring to the image management table 300 in step S603 and subsequent steps.

In step S603, the tag display unit 206 acquires tag information about the image with the image ID i in the image management table 300. Specifically, the tag display unit 206 acquires information about tags added to the image of the image file corresponding to the ID i.

In step S604, the tag display unit 206 determines whether the tags acquired in step S603 include a display target tag identified in step S601. For example, in a case where the selected operation for images is the delete operation, the tag display unit 206 determines whether the tags acquired in step S603 include any one of the tags, “out of focus”, “blur”, “closed eye”, and “red eye”. In a case where the tag display unit 206 determines that the tags acquired in step S603 include a display target tag (YES in step S604), the processing proceeds to step S605. On the other hand, in a case where the tag display unit 206 determines that the tags acquired in step S603 do not include a display target tag (NO in step S604), the processing proceeds to step S606.

Specifically, in step S604, the tag display unit 206 determines whether a tag added to the image with the ID i in the image management table 300 corresponds to a display target tag. Then, in a case where the tag display unit 206 determines that a tag added to the image with the ID i in the image management table 300 corresponds to a display target tag, the processing proceeds to step S605, whereas in a case where the tag display unit 206 determines that no tags added to the image with the ID i in the image management table 300 correspond to a display target tag, the processing proceeds to step S606.

In step S605, the tag display unit 206 displays the corresponding display target tag with the image having the same ID (image ID i). For example, the tag display unit 206 overlays and displays the display target tag on the image so that the display target tag covers the image partially or completely. Methods for displaying the image with the display target tag are not limited to the overlay display, and the display target tag may be displayed, for example, outside and near the image.

In step S606, the tag display unit 206 determines whether i is the last image ID in the image management table 300. Specifically, the tag display unit 206 determines whether the value of the variable i has reached the value of the last image ID in the image management table 300. In a case where the tag display unit 206 determines that i is the last image ID in the image management table 300 (YES in step S606), the tag display process in FIG. 6 is ended, and the processing returns to the process in FIG. 5. Further, in a case where the tag display unit 206 determines that i is not the last image ID in the image management table 300 (NO in step S606), the processing proceeds to step S607.

In step S607, the tag display unit 206 increases the value of the variable i by 1 and updates the value of the variable i. After the value of the variable i is updated, the processing proceeds to step S603, and the processes in step S603 and subsequent steps described above are performed.

The processes in steps S603 to S605 are repeated and the value of the variable i is increased by 1 as described above until the value of the variable i reaches the last image ID in the image management table 300.

In displaying the tag in step S605, in a case where a plurality of tags corresponds to a display target tag, one tag or a predetermined number of tags may be displayed based on priority levels of the tags. According to the present exemplary embodiment, tags are added automatically through analysis of images, so that a tag with the highest likelihood obtained as a result of the analysis of the images is preferentially displayed. Alternatively, tags may be registered in advance in order of priority levels with a tag management table and may be displayed in the order.

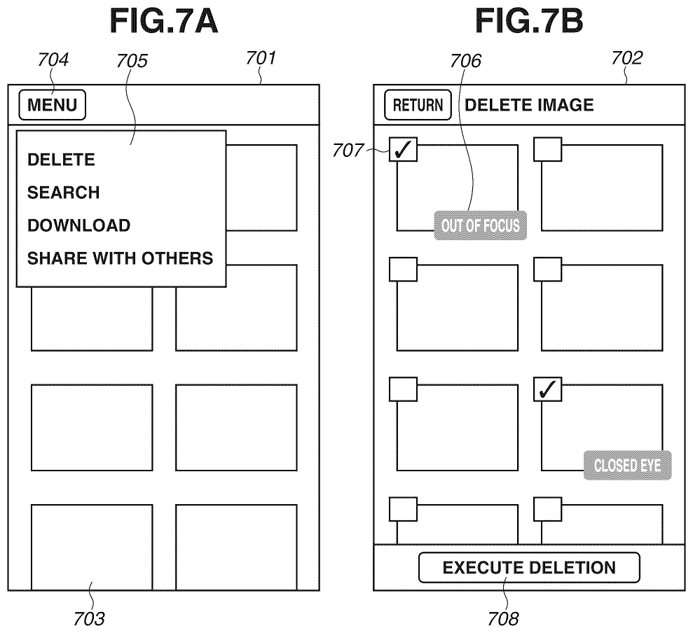

FIGS. 7A and 7B are diagrams illustrating examples of screens displayed in the above-described processes. A screen 701 in FIG. 7A is a screen for selecting an operation for images, and a screen 702 in FIG. 7B is a screen for selecting images based on displayed tags and executing the operation.

In the screen 701 in FIG. 7A, an image 703 is a single image displayed based on an image file in the image management table 300. While eight images are displayed in two columns in the example of the screen 701, the operation unit 203 may scroll the screen based on user operations to display other images. A menu button 704 is a button for selecting an operation for images. For example, the press of the menu button 704 by a user operation on the input device 106 causes an operation list 705 of operations for images to be displayed. In a case where an operation for images is selected by a user operation on the input device 106, the screen 701 switches. For example, in a case where “delete” is selected as an operation for images from the operations displayed in the operation list 705 of operations for images, the screen 701 switches to the screen 702 in FIG. 7B.

The screen 702 in FIG. 7B is an example of a display of a display target tag 706 associated with the delete operation for images. By referring to the tag information, the user operates a checkbox 707 and selects a target image for the delete operation. A button 708 is an execute button for issuing an instruction to execute the delete operation on the image. In a case where the execute button 708 is pressed by a user operation on the input device 106 after an image is selected, the delete operation is executed on the selected image.

According to the first exemplary embodiment, display target tags are identified based on an operation for images that is selected based on a user input, and information about the display target tags among tags added to images is displayed with the images. Thus, in a case where an operation to be executed on images is selected, only suitable tag information is displayed as assists in selecting operation target images, making it easy for the user to select operation target images by referring to the displayed tag information. Further, according to the present exemplary embodiment, images without a display target tag are also displayed. This enables the user to select an image as an operation target image in a case where the user wishes to select the image regardless of tags added to the image or in a case where an added tag is incorrect. Further, information about images without a display target tag may assist in selecting operation target images. For example, in executing the delete operation on images, an image with a display target tag, such as “out of focus”, is a candidate for the deletion, but the user may wish to retain the image in a case where images without a display target tag do not include any similar images. In this case, the present exemplary embodiment is useful.

A second exemplary embodiment will be described. According to the first exemplary embodiment, display target tags are identified based on an operation for images that is selected by a user operation, and the corresponding tag information is displayed to facilitate selection of operation target images. However, in a case where images without a display target tag are also displayed and an operation of selecting operation target images is performed as in the first exemplary embodiment, there is a risk of inadvertently selecting an image that is not intended to be selected as an operation target and executing the operation on the image.

According to the second exemplary embodiment, an example will be described in which warning target tags are identified based on an operation for images that is selected by a user operation, and a warning is displayed in a case where an attempt to execute the operation on an image with the corresponding tag information is made. Differences from the first exemplary embodiment described above will be described.

An information processing apparatus according to the second exemplary embodiment has a similar hardware configuration to the hardware configuration of the information processing apparatus according to the first exemplary embodiment illustrated in FIG. 1.

### <Functional Configuration>

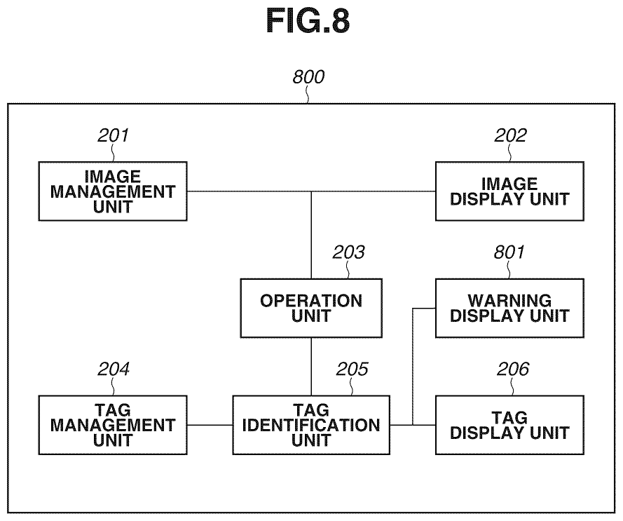

FIG. 8 is a block diagram illustrating an example of a functional configuration of an information processing apparatus 800 according to the second exemplary embodiment.

The information processing apparatus 800 according to the second exemplary embodiment in FIG. 8 is configured by adding a warning display function to the information processing apparatus 100 in FIG. 2. In FIG. 8, each component having a function corresponding to a function of a component in FIG. 2 is assigned the same reference numeral as that of the corresponding component in FIG. 2, and redundant descriptions thereof are omitted. The information processing apparatus 800 includes the image management unit 201, the image display unit 202, the operation unit 203, the tag management unit 204, the tag identification unit 205, the tag display unit 206, and a warning display unit 801.

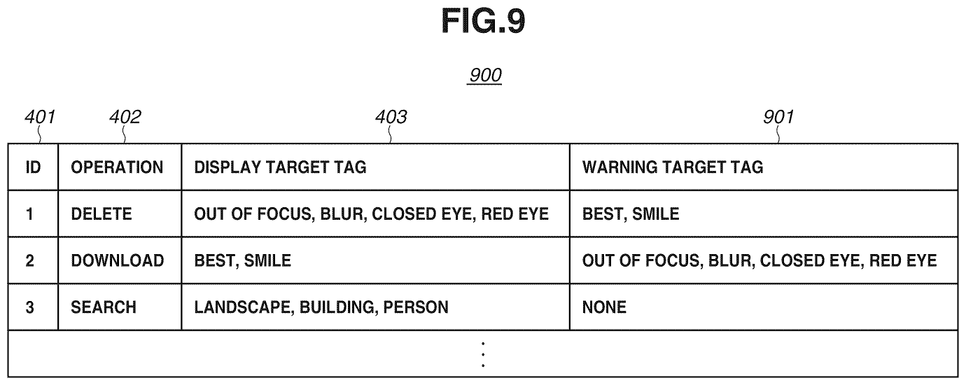

The tag management unit 204 manages warning target tags for which a warning notification is to be issued, in addition to the operations for images and the display target tag information, using a tag management table illustrated as an example in FIG. 9. FIG. 9 is a diagram illustrating an example of a tag management table managed by the tag management unit 204. A tag management table 900 includes warning target tag information, in addition to the tag management table 400 illustrated in FIG. 4. Specifically, the tag management table 900 is a table for managing each operation for images in association with display target tags and warning target tags. Configuration information in the tag management table 900 includes the ID 401 of each operation for images, the operation 402 for the image, the display target tag 403, and a warning target tag 901.

In many cases, warning target tags are tags having the opposite meanings to display target tags. For example, for the delete operation, display target tags are tags having a negative meaning, such as “out of focus”, “blur”, “closed eye”, or “red eye”, whereas warning target tags are tags having a positive meaning, such as “best” or “smile”. Thus, tag groups, such as a positive tag list and a negative tag list, may be managed separately, and a group may be designated as a display target tag. In this case, a group having the opposite meaning to the display target tag may be used as a warning target tag.

The tag identification unit 205 receives information about an operation selected as an operation for images by a user input from the operation unit 203 and identifies display target tags and warning target tags based on the tag management table managed by the tag management unit 204. In executing the operation for images, the warning display unit 801 displays a warning in a case where tags added to images selected as operation target images include a warning target tag in executing an operation for images. The warning display unit 801 is an example of a third display unit.

### <Processing Procedure>

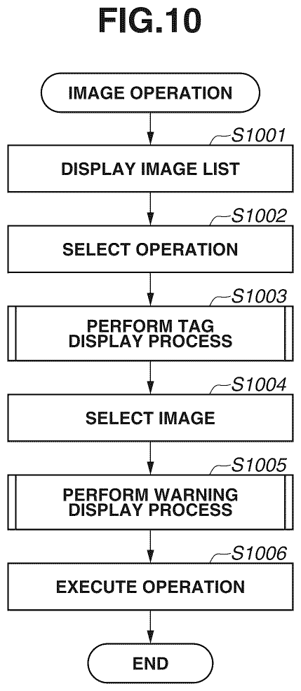

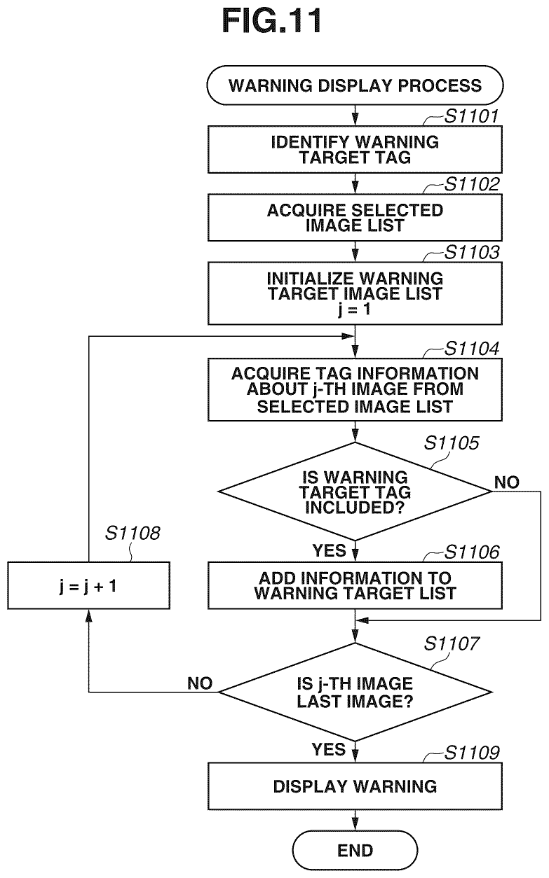

An example of processes of the information processing apparatus 800 according to the second exemplary embodiment will be described with reference to FIGS. 10 and 11. FIG. 10 is a flowchart illustrating an example of a process of the information processing apparatus 800 according to the second exemplary embodiment. FIG. 10 illustrates a procedure of processing of the information processing apparatus 800 from displaying an image list to executing an operation on images.

In step S1001, the image display unit 202 displays an image list based on information in the image management table 300 managed by the image management unit 201.

In step S1002, the operation unit 203 receives a user input related to selection of an operation for images and selects an operation for images.

In step S1003, the tag identification unit 205 and the tag display unit 206 perform the tag display process.

In step S1004, the operation unit 203 receives a user input related to selection of images and selects operation target images.

The processes in steps S1001 to S1004 correspond to the processes in steps S501 to S504 in FIG. 5 according to the first exemplary embodiment, so that redundant detailed descriptions thereof are omitted. Further, details of the tag display process in step S1003 are similar to the tag display process in FIG. 6 according to the first exemplary embodiment.

In step S1005, in a case where the operation unit 203 receives a user input related to execution of the operation via the input device 106, the tag identification unit 205 and the warning display unit 801 perform a warning display process to display a warning based on the operation for images that is selected in step S1002. In the warning display process, a warning is displayed in a case where an attempt to execute the operation on an image with warning target tag information is made based on information in the image management table 300 managed by the image management unit 201 and information in the tag management table 900 managed by the tag management unit 204. Details of the warning display process in step S1005 will be described below.

In step S1006, the operation unit 203 executes the operation on the images selected as operation targets based on the user input related to execution of the operation that is received via the input device 106.

FIG. 11 is a flowchart illustrating an example of the warning display process in step S1005 in the flowchart in FIG. 10.

In step S1101, the tag identification unit 205 acquires information about the operation for images that is selected in step S1002 from the operation unit 203 and identifies warning target tags based on information in the tag management table 900 managed by the tag management unit 204. For example, in a case where the selected operation for images is the delete operation, the tag identification unit 205 identifies the “best” and “smile” tags as warning target tags.

In step S1102, the warning display unit 801 acquires information about the images selected as operation targets in step S1004 as a selected image list.

In step S1103, the warning display unit 801 initializes a warning target image list to empty and initializes a variable j, which is an index of the selected image list, to 1. The variable j is used in referring to the selected image list in the processes in step S1104 and subsequent steps.

In step S1104, the warning display unit 801 acquires tag information about the j-th image from the selected image list. Specifically, the warning display unit 801 acquires information about tags added to the j-th image in the selected image list.

In step S1105, the warning display unit 801 determines whether the tags acquired in step S1104 include a warning target tag identified in step S1101. For example, in a case where the selected operation for images is the delete operation, the warning display unit 801 determines whether the tags acquired in step S1104 include either of the tags, “best” and “smile”. In a case where the warning display unit 801 determines that the tags acquired in step S1104 include a warning target tag (YES in step S1105), the processing proceeds to step S1106. On the other hand, in a case where the warning display unit 801 determines that the tags acquired in step S1104 do not include a warning target tag (NO in step S1105), the processing proceeds to step S1107.

Specifically, in step S1105, the warning display unit 801 determines whether a tag added to the j-th image in the selected image list corresponds to a warning target tag. Then, in a case where the warning display unit 801 determines that a tag added to the j-th image in the selected image list corresponds to a warning target tag, the processing proceeds to step S1106, whereas in a case where the warning display unit 801 determines that no tags added to the j-th image in the selected image list correspond to a warning target tag, the processing proceeds to step S1107.

In step S1106, the warning display unit 801 adds, to the warning target image list, information about the image determined to include a warning target tag in step S1105. Specifically, the warning display unit 801 adds information about the j-th image in the selected image list to the warning target image list.

In step S1107, the warning display unit 801 determines whether the j-th image is the last image in the selected image list. In a case where the warning display unit 801 determines that the j-th image is the last image in the selected image list (YES in step S1107), the processing proceeds to step S1109. On the other hand, in a case where the warning display unit 801 determines that the j-th image is not the last image in the selected image list (NO in step S1107), the processing proceeds to step S1108.

In step S1108, the warning display unit 801 increases the value of the variable j by 1 and updates the value of the variable j. After the value of the variable j is updated, the processing proceeds to step S1104, and the processes in step S1104 and subsequent steps are performed. The processes in steps S1104 to S1106 are repeated and the value of the variable j is increased by 1 as described above until the j-th image becomes the last image in the selected image list.

In step S1109, the warning display unit 801 displays a warning by displaying the image added to the warning target image list and the tag information. In a case where the warning target image list remains empty and includes no images, nothing is displayed. By referring to the image displayed with the warning and the tag information, the user changes the image selected as an operation target to an unselected state via the input device 106 as appropriate to exclude the image from the operation targets. After the warning display in step S1109 ends, the warning display process in FIG. 11 ends, and the processing returns to the process in FIG. 10.

In displaying the warning in step S1109, in a case where the warning target image list includes a plurality of images, the images may be displayed sequentially based on priority levels of the images instead of displaying all the images at one time. According to the present exemplary embodiment, the images are displayed based on likelihoods of tags that are obtained as a result of analyzing the images so that an image with a warning target tag with a high likelihood is preferentially displayed. Further, in a case where a plurality of warning target tags is added to a single image, one tag or a predetermined number of tags may be displayed based on priority levels of the tags as in the first exemplary embodiment.

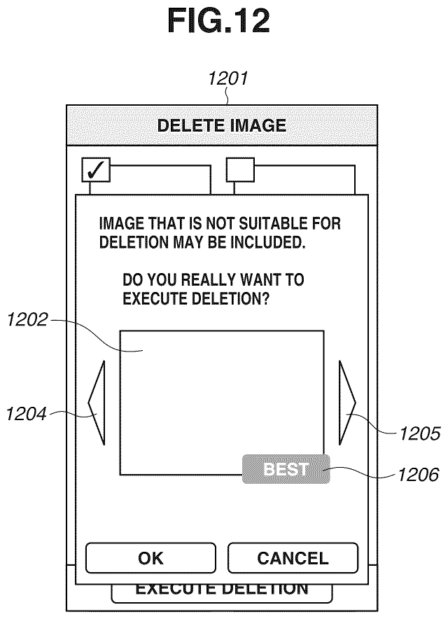

FIG. 12 is a diagram illustrating an example of a screen 1201 displaying a warning in the above-described process. In the screen 1201, an image 1202 is a single image added to the warning target image list in step S1106 in FIG. 11, and tag information 1206 is information about a tag corresponding to a warning target tag added to the image. Buttons 1204 and 1205 are buttons for switching the display to a previous or next image in the warning target image list.

The second exemplary embodiment produces similar advantageous effects to those produced by the first exemplary embodiment. Furthermore, according to the second exemplary embodiment, warning target tags are identified based on an operation for images that is selected by a user input, and a warning is displayed in a case where an attempt to execute the operation on an image with a warning target tag is made. As described above, in a case where an attempt to execute the operation on an image with a warning target tag is made, a warning is displayed before the operation is executed. This makes it possible to prompt the user to check in a case where the image may have been selected inadvertently. For example, in a case where an image with a tag indicating a best shot is selected as an operation target in executing the delete operation, the image and the tag information are presented to prompt the user to confirm whether to delete the image.

While various examples of exemplary embodiments are described above, the present disclosure can also be implemented in other forms, such as a system, an apparatus, a method, a program, or a recording medium (a storage medium). Specifically, the present disclosure is applicable to a system including a plurality of devices (e.g., a host computer, an interface device, an imaging apparatus, a web application) or an apparatus consisting of a single device.

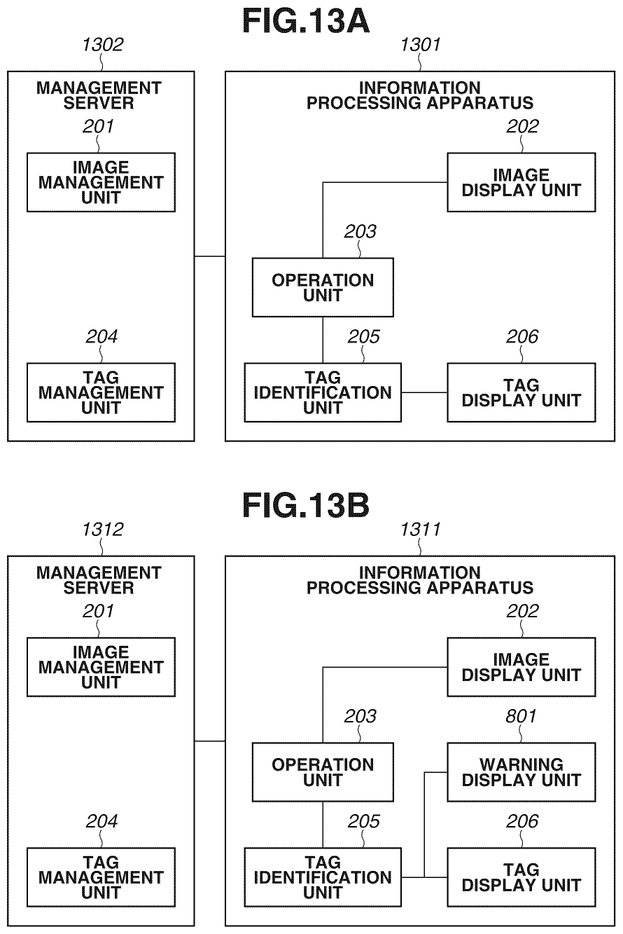

FIG. 13A is a diagram illustrating an example of a system configuration configured by modifying the functional configuration of the information processing apparatus 100 according to the first exemplary embodiment in FIG. 2 to include two devices that are a server (management server 1302) configured to manage images and tags and an apparatus (information processing apparatus 1301) configured to operate images. FIG. 13B is a diagram illustrating an example of a system configuration configured by modifying the functional configuration of the information processing apparatus 800 according to the second exemplary embodiment in FIG. 8 to include two devices that are a server (management server 1312) configured to manage images and tags and an apparatus (information processing apparatus 1311) configured to operate images. In FIGS. 13A and 13B, each functional unit corresponding to a functional unit in FIG. 2 or 8 is assigned the same reference numeral as that of the corresponding functional unit. The functional units of the devices correspond to those described above, and the devices perform processing between the functional units via the communication device 107.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-080997, filed May 16, 2023, which is hereby incorporated by reference herein in its entirety.

What is claimed is:

1. An information processing apparatus comprising:
a first display unit configured to display one or more images;
an operation unit configured to select an operation for the one or more images;
an identification unit configured to identify at least one display target tag based on the selected operation; and
a second display unit configured to display information about the at least one display target tag with the one or more images in a case where a tag added to the one or more images corresponds to the at least one display target tag.

2. The information processing apparatus according to claim 1,
wherein the at least one display target tag comprises a plurality of display target tags, and
wherein in a case where the plurality of display target tags is added to one image of the one or more images, the second display unit displays information about one tag or a predetermined number of tags among the plurality of added display target tags.

3. The information processing apparatus according to claim 2,
wherein the tag added to the one or more images is added based on a priority level of the tag that is obtained as a result of analyzing the one or more images, and
wherein the second display unit preferentially displays information about a display target tag with a higher priority level among the plurality of display target tags.

4. The information processing apparatus according to claim 1, wherein the identification unit identifies the at least one display target tag based on information in a table associating the operation for the one or more images with the at least one display target tag.

5. The information processing apparatus according to claim 1, wherein after selecting the operation for the one or more images, the operation unit selects at least one operation target image from the one or more images based on an input and executes the selected operation on the selected at least one operation target image.

6. The information processing apparatus according to claim 5, wherein the identification unit identifies a warning target tag based on the selected operation,
the information processing apparatus further comprising a third display unit configured to display a warning in a case where a tag added to the at least one operation target image corresponds to the warning target tag in executing the selected operation by the operation unit.

7. The information processing apparatus according to claim 6,
wherein the tag added to the one or more images is added based on a likelihood of the tag that is obtained as a result of analyzing the one or more images,
wherein the at least one operation target image comprises a plurality of operation target images, and
wherein in a case where the warning target tag is added to the plurality of operation target images, the third display unit preferentially displays a warning related to an operation target image with the warning target tag with a higher priority level.

8. The information processing apparatus according to claim 5, wherein the operation for the one or more images includes at least one of a delete operation, a download operation, and a share operation.

9. The information processing apparatus according to claim 1, wherein the second display unit overlays and displays the information about the at least one display target tag on the one or more images.

10. The information processing apparatus according to claim 1, wherein the second display unit displays the information about the at least one display target tag outside and near the one or more images.

11. A method for controlling an information processing apparatus configured to display an image and information about a tag, the method comprising:
displaying, as first display, one or more images;
selecting an operation for the one or more images;
identifying a display target tag based on the selected operation; and
displaying, as second display, information about the display target tag with the one or more images in a case where a tag added to the one or more images corresponds to the display target tag.

12. A non-transitory storage medium storing a program causing an information processing apparatus configured to display an image and information about a tag to execute a control method, the control method comprising:
displaying, as first display, one or more images;
selecting an operation for the one or more images;
identifying a display target tag based on the selected operation; and
displaying, as second display, information about the display target tag with the one or more images in a case where a tag added to the one or more images corresponds to the display target tag.
